(19) United States
(12) Patent Application Publication
(10) Pub. No.: US 2024/0351268 A1
(43) Pub. Date: Oct. 24, 2024

(54) DEVICE AND METHOD FOR REMOVING ELASTOMERIC POLYMER LINER MATERIAL FROM INSIDE A PIPE

(71) Applicant: KED Holdings Inc., Kamloops (CA)

(72) Inventors: Rhaine Jesse IVANISKI, Kamloops (CA); Elliott D.K. AURIAT, Kamloops (CA)

(73) Assignee: KED Holdings Inc., Kamloops (CA)

(21) Appl. No.: 18/763,927

(22) Filed: Jul. 3, 2024

Related U.S. Application Data
(63) Continuation of application No. PCT/CA2022/050009, filed on Jan. 6, 2022.

(51) Int. Cl. B29C 63/00; B26D 1/00; B26D 3/28

(52) U.S. Cl. CPC B29C 63/0013; B26D 1/0006; B26D 3/28

(57) ABSTRACT

In one aspect, a device for facilitating removal of elastomeric polymer liner material from inside a pipe comprises a knife having an axial blade portion and a radial blade portion joined to form a heel with respective cutting edges of the axial and radial blade portions facing in the same direction. The knife has a working orientation in which the axial and radial blade portions are oriented axially and radially, respectively, relative to the pipe and the axial blade portion is further from the pipe axis than the radial blade portion. Rotation of the knife about the pipe axis in the working orientation with the cutting edges leading and the knife contacting the elastomeric polymer liner material causes the cutting edges of the radial and axial blade portions to cut through the elastomeric polymer liner material in the radial and axial dimensions, respectively, of the pipe.

### CROSS-REFERENCE TO RELATED APPLICATIONS

This is a continuation of International PCT application No. PCT/CA2022/050009, entitled DEVICE AND METHOD FOR REMOVING AN ELASTOMERIC POLYMER LINER FROM INSIDE AN END SECTION OF A PIPE, filed on Jan. 6, 2022, which is incorporated herein by reference.

### TECHNICAL FIELD

The present application pertains to pipe having an elastomeric polymer liner, and more specifically to a device and method for removing elastomeric polymer liner material from inside a pipe.

### BACKGROUND

Cylindrical metal pipes, such as 30-inch inner diameter steel pipes commonly used for oilsands and mining tailings pipelines, may have a liner bonded to an interior surface of the pipe wall. The liner may be made from an elastomeric polymer, such as polyurethane or urethane. Examples of commercially available polyurethane products from which pipe liners may be made include RoPlasthan™ and RoCoat™ products from ROSEN™ Swiss AG and Irethane™ products (e.g., Irethane™ 2855) sold by ITW Performance Polymers. The liner protects the metal pipe from abrasion by hard particulate matter that may be mixed in with liquid being carried through the pipe (e.g., quartz sand). A metal pipe having an elastomeric polymer liner may be referred to as a “lined pipe.”

An elastomeric polymer liner may have substantial thickness, e.g., approximately 1.5 to 2.0 inches for a 30-inch inner diameter metal pipe. The durometer (hardness) of different elastomeric polymer materials may vary, but the materials all generally have a degree of resiliency. This characteristic contributes to the abrasion-resistance of the liner, even as compared with harder materials of lesser resiliency.

Lined pipes are commonly sold in predetermined lengths or “spools,” so called because of the annular flange at each end of the pipe. For example, 30-inch inner diameter pipes are commonly sold in 60-foot lengths, among others. A pipeline project may necessitate the purchase of many modular lined pipe spools of various lengths, depending on the planned pipeline layout.

Dynamically changing circumstances in the field may render a purchased lined pipe spool too long for its intended purpose. This may occur, e.g., if environmental considerations force re-routing of an oil pipeline from a planned layout. In such circumstances, shorter lengths of lined pipe may be needed to facilitate a new pipeline layout. Although shorter spools of lined pipe could possibly be ordered from a manufacturer, the associated additional cost and delivery delay may be undesirable.

Severing a spool of lined pipe into shorter lengths for re-use in the field may be viewed as a lower cost and timelier alternative. Severing may be performed using a known annular pipe machining lathe, also known as a split-frame lathe, clamshell lathe, or simply annular lathe. This type of lathe has the appearance of a ring that is clamped to a pipe exterior substantially coaxially therewith. The ring comprises two adjacent annular parts: a stationary part and a rotating part. The stationary part surrounds the pipe and is clamped to the pipe exterior. The rotating part also surrounds the pipe and is rotatable about the pipe relative to the stationary part. The rotating part has a tool mount that can be fitted to carry a tool bit having an extremely hard tip that points radially inwardly towards the pipe axis. Rotation of the rotating part of the lathe causes the tool bit to orbit the pipe. Simultaneously, the lathe can be made to advance the tool bit radially inwardly so that its tip progressively cuts into and through the pipe wall, from the outside in, over the course of multiple orbits of the pipe.

The severed ends of a pipe may lack any brackets or flanges to facilitate interconnection with adjacent pipe spools. Welding of brackets or flanges onto the ends of a severed lined pipe may expose the pipe wall to extremely high temperatures that may be conducted through to the liner. This may be unsafe for workers, e.g., when the liner is made from an elastomeric polymer material such as polyurethane. The reason is that heating of the elastomeric polymer liner material above a threshold temperature may release dangerous gases, such as hydrogen cyanide.

### SUMMARY

In one aspect, there is provided a device for facilitating removal of elastomeric polymer liner material from inside a pipe, the device comprising: a knife having an axial blade portion and a radial blade portion joined to form a heel with respective cutting edges of the axial and radial blade portions facing in the same direction, the knife having a working orientation in which the axial and radial blade portions are oriented axially and radially, respectively, relative to the pipe and the axial blade portion is further from an axis of the pipe than the radial blade portion; wherein rotation of the knife about the axis of the pipe in the working orientation with the cutting edges leading and with the knife in contact with the elastomeric polymer liner material causes the cutting edge of the axial blade portion to cut through the elastomeric polymer liner material along an annular trajectory and additionally causes the cutting edge of the radial blade portion to simultaneously cut through the elastomeric polymer liner material in a radial dimension of the pipe.

In another aspect, there is provided a method of facilitating removal of elastomeric polymer liner material lining an inner surface of a pipe, the method comprising: orienting a knife in a working orientation with respect to the pipe, the knife having an axial blade portion and a radial blade portion joined at a heel with respective cutting edges of the axial and radial blade portions facing in the same direction, wherein the axial and radial blade portions are oriented axially and radially, respectively, relative to the pipe, with the axial blade portion being further from an axis of the pipe than the radial blade portion; and rotating the knife about the axis of the pipe in the working orientation with the cutting edges leading and with the knife in contact with the elastomeric polymer liner material to cause the cutting edge of the axial blade portion to cut through the elastomeric polymer liner material along an annular trajectory and to simultaneously cause the cutting edge of the radial blade portion to cut through the elastomeric polymer liner material in a radial dimension of the pipe.

In a further aspect, there is provided a device for facilitating removal of elastomeric polymer liner material from inside an end section of a pipe, the device comprising: a knife having an axial blade portion and a radial blade portion joined to form a heel with respective cutting edges of the axial and radial blade portions facing in the same direction; a knife support structure configured to support the knife inside the end section of the pipe from an exterior periphery of the pipe with the knife in a working orientation in which the axial and radial blade portions are oriented axially and radially, respectively, relative to the pipe and the axial blade portion is further from an axis of the pipe than the radial blade portion; a radial feed mechanism operable to, upon rotation of the knife support structure about the axis of the pipe with knife held in the working orientation and the cutting edges leading, progressively advance the knife radially outwardly from an inboard position in which the cutting edge of the axial blade portion is radially inward of the elastomeric polymer material lining the inner surface of the pipe to an outboard position in which the cutting edge of the axial blade portion is adjacent to the inner surface of the pipe; and an axial feed mechanism operable to, upon rotation of the knife support structure about the axis of the pipe with knife held in the working orientation and the cutting edges leading, progressively move the knife, in the outboard position, axially and heel-first along the end section of the pipe.

In another aspect, there is provided a method of facilitating removal of elastomeric polymer material lining an inner surface of an end section of a pipe, the method comprising: securing an annular rotary drive mechanism about an exterior periphery of the pipe; attaching a knife support structure to the annular rotary drive mechanism, the attached knife support structure being configured to support a knife inside the end section of the pipe in a working orientation, the knife having an axial blade portion and a radial blade portion joined at a heel with respective cutting edges of the axial and radial blade portions facing in the same direction, the axial and radial blade portions being oriented axially and radially, respectively, relative to the pipe with the axial blade portion being further from an axis of the pipe than the radial blade portion when the knife is in the working orientation; while the annular rotary drive mechanism rotates the knife support structure about the axis of the pipe with the knife in the working orientation and the cutting edges leading, progressively radially outwardly shaving away an annular portion of the elastomeric polymer material from the end section of the pipe by progressively advancing the knife radially outwardly from an inboard position in which the cutting edge of the axial blade portion is radially inward of the elastomeric polymer material lining the inner surface of the pipe to an outboard position in which the cutting edge of the axial blade portion of the knife is adjacent to the inner surface of the pipe; and then while the annular rotary drive mechanism rotates the knife support structure about the axis of the pipe with the knife in the working orientation and the cutting edges leading, progressively axially cutting away a substantial remainder of the elastomeric polymer material from the end section of the pipe by progressively moving the knife axially along the end section of the pipe heel-first.

In a further aspect, there is provided device for facilitating removal of elastomeric polymer liner material from inside an end section of a pipe, the device comprising: knife means having an axial blade portion and a radial blade portion joined to form a heel with respective cutting edges of the axial and radial blade portions facing in the same direction; knife support means configured to support the knife means inside the end section of the pipe from an exterior periphery of the pipe with the knife means in a working orientation in which the axial and radial blade portions are oriented axially and radially, respectively, relative to the pipe and the axial blade portion is further from an axis of the pipe than the radial blade portion; radial feed means operable to, upon rotation of the knife support means about the axis of the pipe with knife means held in the working orientation and the cutting edges leading, progressively advance the knife means radially outwardly from an inboard position in which the cutting edge of the axial blade portion is radially inward of the elastomeric polymer material lining the inner surface of the pipe to an outboard position in which the cutting edge of the axial blade portion is adjacent to the inner surface of the pipe; and axial feed means operable to, upon rotation of the knife support means about the axis of the pipe with knife means held in the working orientation and the cutting edges leading, progressively move the knife means, in the outboard position, axially and heel-first along the end section of the pipe.

### BRIEF DESCRIPTION OF THE DRAWINGS

In the figures which illustrate example embodiments,

FIG. 1 is a perspective view of a lined pipe spool;

FIG. 2 is a simplified perspective view of an annular lathe;

FIGS. 3 and 4 are perspective views depicted different stages of installation of the annular lathe of FIG. 2 onto the lined pipe spool of FIG. 1;

FIG. 5 is a simplified perspective view of a lined pipe severed from the lined pipe spool of FIG. 1 by the annular lathe of FIG. 2 with the annular lathe still attached;

FIG. 6 is a perspective view of a device for facilitating removal of elastomeric polymer liner material from inside an end section of a lined pipe;

FIG. 7 is a perspective view of the device of FIG. 6 after its attachment to the annular lathe of FIG. 2;

FIG. 8 is an exploded view of the device of FIG. 6;

FIGS. 9 and 10 are isometric views of a knife component of the device of FIG. 6 from two different perspectives;

FIGS. 11 and 12 illustrate the knife of FIGS. 9 and 10 in bottom view and left side elevation view, respectively;

FIG. 13 is a front elevation view of the knife of FIGS. 9 and 10 in an outboard position;

FIG. 14 is a schematic side view of the device of FIG. 6, attached to the annular lathe of FIG. 2 with the lined pipe of FIG. 5 shown in cross section, at the commencement of a plunge cutting stage of operation;

FIG. 15 is a schematic side view of the device of FIG. 6, attached to the annular lathe of FIG. 2 with the lined pipe of FIG. 5 shown in cross section, during the plunge cutting stage of operation;

FIG. 16 is a perspective view of the knife of FIG. 9, as viewed from the open end of the lined pipe, during the plunge cutting stage of operation of the device of FIG. 6;

FIG. 17 is a schematic side view of the device of FIG. 6, attached to the annular lathe of FIG. 2 with the lined pipe of FIG. 5 shown in cross section, at the conclusion of the plunge cutting stage of operation;

FIG. 18 is a schematic side view of the device of FIG. 6, attached to the annular lathe of FIG. 2 with the lined pipe of FIG. 5 in cross section, during an axial cutting stage of operation;

FIG. 19 is a perspective view of the knife of FIG. 9, as viewed from the open end of the lined pipe, during the axial cutting stage of operation of the device of FIG. 6;

FIG. 20 is a perspective view of a stripper carriage;

FIGS. 21 and 22 are isometric views of an alternative embodiment of a knife that may be used with the device of FIG. 6 from two different perspectives; and

FIG. 23 is a front elevation view of the knife of FIGS. 21 and 22 in an outboard position.

### DETAILED DESCRIPTION

In this document, any use of the term “exemplary” should be understood to mean “an example of” and not necessarily to mean that the example is preferable or optimal in some way. Terms such as “top,” “bottom,” “left,” “right,” “side,” and “front” may be used to describe features of some embodiments in this description but should not be understood to necessarily connote an orientation of the embodiments during manufacture or use.

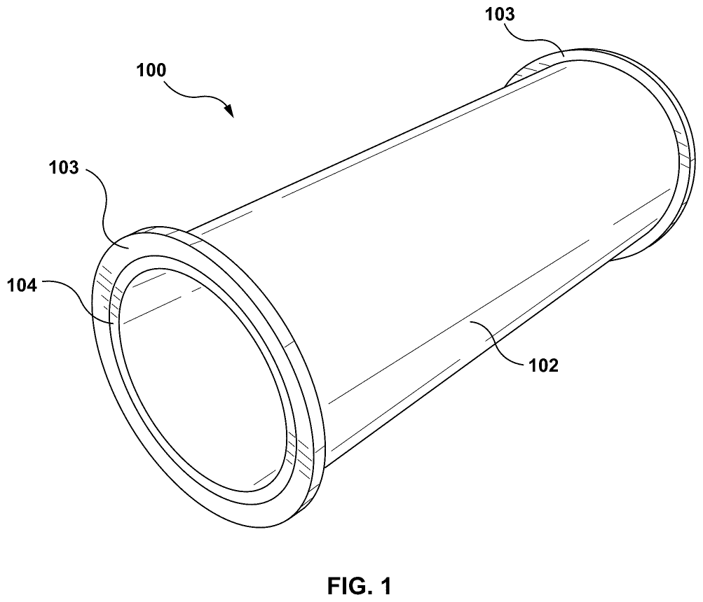

Referring to FIG. 1, a lined pipe spool 100 is depicted in perspective view. The lined pipe spool 100 comprises a substantially cylindrical metal (e.g., steel) pipe 102. The metal pipe 102 has annular flanges 103 at either end to facilitate interconnection with adjacent pipe spools. The flanges 103 may have through holes spaced about the circumference of each flange (not expressly depicted in FIG. 1) to receive bolts for interconnecting aligned flanges of adjacent pipe spools. In the illustrated example, the inner diameter of the pipe 102 is 30 inches, and the thickness of the liner 104 is 1.5 inches. Alternative embodiments may be used with lined pipes of other diameters and liner thicknesses.

The lined pipe spool 100 further comprises a substantially cylindrical elastomeric polymer liner 104 bonded to an inner surface of the pipe 102. In this example, the liner 104 is made from polyurethane, such as RoCoat™ products from ROSEN™ Swiss AG. The durometer of the polyurethane in this example may be approximately 87 Shore A. The durometer of the elastomeric polymer liner material may differ in alternative embodiments.

The lined pipe spool 100 may for example be intended for use in constructing a pipeline for carrying oil sands or mining tailings that may comprise solid particulate matter such as sand. The liner 104 may be intended to prevent damage to the pipe 102 from the solid particular matter and to thereby extend its working life.

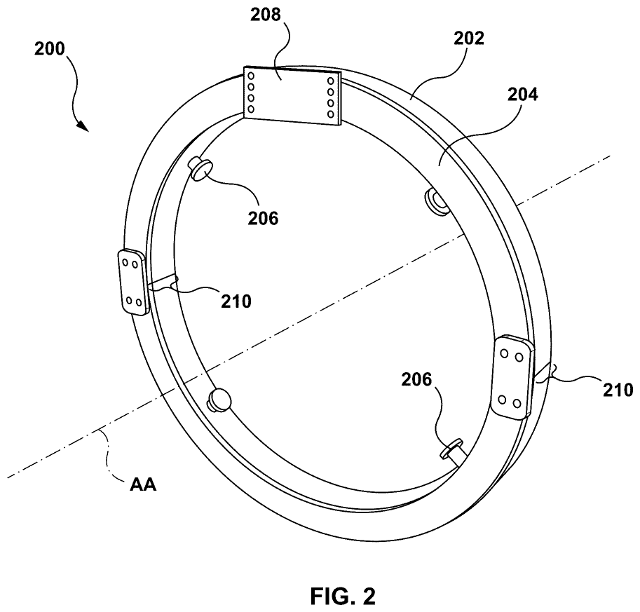

At a pipeline construction site, it may become necessary or prudent to sever the lined pipe spool 100 into two shorter lengths, e.g., so that at least one of the lengths can be used for interconnection with other lined pipe spools. Severing may be performed in the field using an annular lathe, as depicted in FIG. 2.

FIG. 2 is a simplified perspective view of an annular lathe 200, a form of annular rotary drive mechanism. The annular lathe 200 comprises two adjacent, coaxial annular parts: a stationary annular part 202 and a rotatable annular part 204.

The stationary annular part 202 is securable (e.g., clampable) to a pipe exterior. Multiple locator feet 206 (four illustrated) may project radially inwardly from an inner face of the stationary annular part 202. These may serve as the point of contact between the pipe exterior and the annular lathe 200.

The rotatable annular part 204 is rotatable about axis AA relative to the stationary annular part 202. The rotation may be driven by a motor, such as a pneumatic motor, that may be mounted to a motor mount (not depicted) in the stationary part 202. The motor is typically capable of generating significant force, e.g., sufficient to drive a cutting tool bit mounted to the rotating annular part 204 as it cuts through the metal wall of the pipe. A tool mount 208, which may be a plate fixedly attached to a face of the rotatable annular part 204 (e.g., by welding or bolts), may serve as the mounting location for such a cutting tool bit.

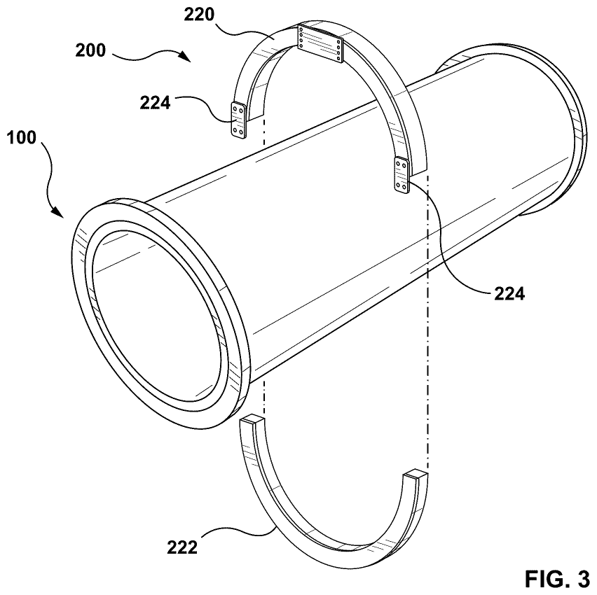

The annular lathe 200 is depicted in FIG. 2 in an assembled annular state. The lathe 200 is also separable along a bisecting joint 210 into two semi-annular (C-shaped) halves to facilitate its installation onto a pipe. This is depicted in FIGS. 3 and 4.

FIGS. 3 and 4 are simplified perspective views depicting the annular lathe 200 of FIG. 2 during and after installation onto the lined pipe spool 100 of FIG. 1, respectively. In FIG. 3, the annular lathe 200 has been separated into two C-shaped, semi-annular halves 220 and 222 to facilitate installation. The top semi-annular half 220 of the annular lathe 200 comprises a semi-annular half of each of the stationary part 202 and the rotating part 204 and two connector brackets 224. The bottom semi-annular half 222 of the annular lathe 200 comprises a complementary semi-annular half of each of the stationary part 202 and the rotating part 204. For clarity, the locator feet 206 are omitted from FIG. 3.

Referring to FIG. 4, the top and bottom semi-annular halves 220 and 222 of annular lathe 200 have been joined in a conventional manner, e.g., using brackets 224 and/or other connectors. The assembled annular lathe 200 has been secured about an exterior periphery of the lined pipe spool 100 at a desired pipe severing location, with locator feet 206 (not visible) holding the stationary part 202 of the annular lathe 200 substantially coaxially with the pipe spool 100. The lengths of the locator feet 206 may be adjustable to facilitate centering of the annular lathe 200 on the cylindrical lined pipe spool 100.

In FIG. 4, a tool slide block assembly 226 (also referred to simply as tool slide 226) having a base 228 and a slidable block 230 holding a cutting tool bit 232 is mounted to the tool mount 208 of rotatable annular part 204. The cutting tool bit 232 is oriented so that its tip 234 points radially inwardly toward the pipe spool 100.

The annular lathe 200 may be used to sever the lined pipe spool 100 in a conventional manner, as follows. Firstly, the rotatable annular part 204 is made to rotate relative to the stationary part 202. This will cause the tool mount 208, and the attached tool slide block assembly 226, to orbit the pipe 102. The tip 234 of tool bit 232 will initially be radially clear of the pipe 102.

As the tool slide block assembly 226 continues to orbit the pipe 102, the tool block 230 holding tool bit 232 may be made to slide radially inwardly relative to base 228. This may be achieved by causing a threaded rod (not illustrated) that is in fixed radial relation to base 228 and which engages a radially oriented threaded bore (not illustrated) through block 230 to rotate. Rotation of the rod may be caused by a stationary trip engaging a star wheel (not illustrated) disposed at a radially distal end of the rod. The trip may rotate the star wheel and threaded rod through a predetermined angle with each orbit of the tool mount 226, causing the tool mount 226 to slide incrementally radially inwardly with each orbit of the tool mount 226 about the pipe 102. When the tip 234 of the tool bit 232 reaches the pipe 102, it will begin to progressively cut through the pipe 102 from the outside in. Thereafter, the same tool bit 232 will continue to cut through the elastomeric polymer liner 104, also from the outside in.

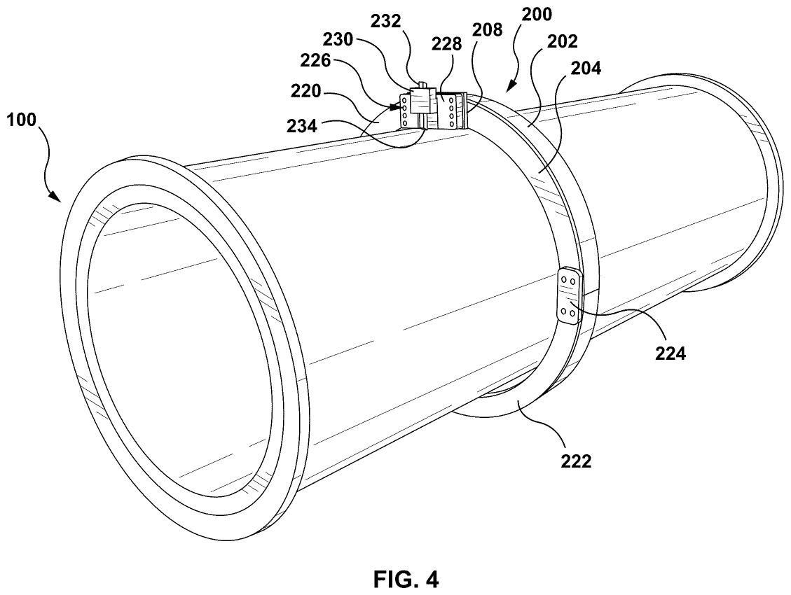

A severed part of the lined pipe spool 100 may be removed, leaving the other severed part of the lined pipe spool 100, i.e., the part to which the annular lathe 200 has been clamped. The latter severed part, referred to as lined pipe 150, is shown in simplified perspective view in FIG. 5.

Referring to FIG. 5, it can be seen that the open end 160 of lined pipe 150, where severing has just been completed, lacks a flange to facilitate interconnection of that end 160 of the pipe 150 with an adjacent pipe spool. It may accordingly be desired to weld a number of brackets to an exterior of the pipe 102 about the open end 160 to facilitate such interconnection. To limit exposure of welders to dangerous gases that may be emitted by the elastomeric polymer liner 104 upon exposure to heat from welding or possibly even combustion of the liner 104, it may be considered prudent or necessary to remove the liner 104 from an end section 162 of the lined pipe 150 before any such welding is performed. The end section 162 may for example be 18 inches long.

However, conventional methods of elastomeric polymer liner removal may be considered impractical in the field. Perhaps the most common approach for removing an elastomeric polymer liner bonded to the inner surface of a metal pipe is using high-pressure water jets, which is conventionally done in a factory setting. Robotic arms carrying nozzles capable of spraying high-pressure (e.g., one hundred thousand PSI) water jets may be extended into a lined pipe. The water jets may be controlled so as to cut away the liner material, including any bond that may be formed between the material and the pipe wall (which may be very strong), without damaging the steel pipe. The temperature of the water may be kept cold to prevent the elastomeric polymer liner from undergoing an exothermic reaction that may release dangerous gases during liner removal.

The equipment required for liner removal using high pressure water jets may be considered impractical for liner removal in the field. The lined pipe 150 could be shipped to the factory for liner removal using water jets. However, this may necessitate the use of heavy equipment, such as a crane, to load and unload the lined pipe onto and from a flatbed truck for delivery. Undesired delay and shipping costs may result.

The applicant considered various alternative approaches for elastomeric polymer liner removal in the field. However, the very characteristics of the elastomeric polymer material that serve to protect the metal pipes that have been lined with the material—including the durability and resiliency of the material—can also make liner removal difficult.

For example, one approach attempted by the applicant was using a milling bit to mill away the liner in the manner of a router. However, it was found that milling tends to shred the elastomeric polymer material in unpredictable ways and to leave an irregular surface texture. Moreover, there may be a risk of metal pipe damage when a milling bit approached the inner surface of a metal pipe. For some industries (e.g., the petroleum pipeline industry), even a comparatively small degree of damage to a metal pipe, such as a 1/16″ deep cut, can render the pipe unusable in view of strict standards for environmental safety.

The applicant has therefore developed the below-described device to facilitate elastomeric polymer liner removal. In overview, the device utilizes a sharp knife having two blade portions to cut away the elastomeric polymer material from an end section of a lined pipe in ribbons or strips. The cutting is performed in two operational stages, which may be followed by a stripping phase, as will be described below. The device can be used in the field to remove the elastomeric polymer liner from an end section of a lined pipe relatively quickly and with limited risk of damage to an inner surface of the metal pipe. Moreover, the device can be actuated (at least in part) by a commercially available annular lathe. Conveniently, for at least some embodiments, the device may be utilized to facilitate elastomeric polymer liner removal from an end of a severed pipe using same annular lathe that severed the pipe. In some embodiments, such an annular lathe may conveniently remain continuously clamped to the pipe during both pipe severing and elastomeric polymer liner removal, which may promote efficiency in performing these operations quickly.

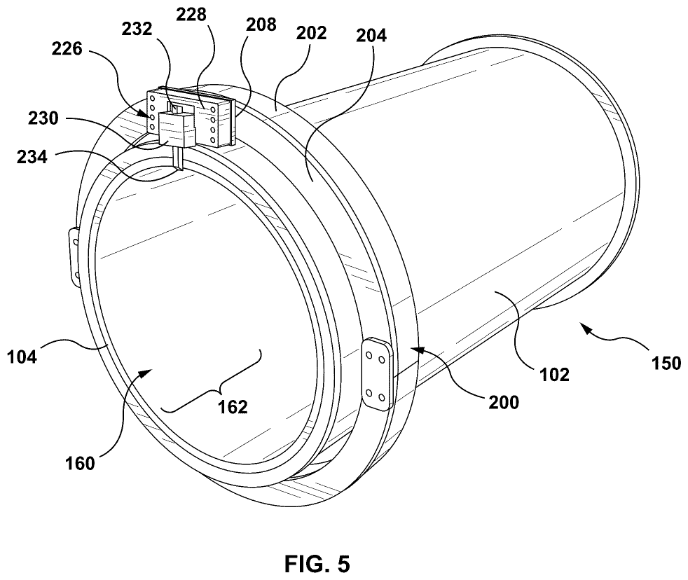

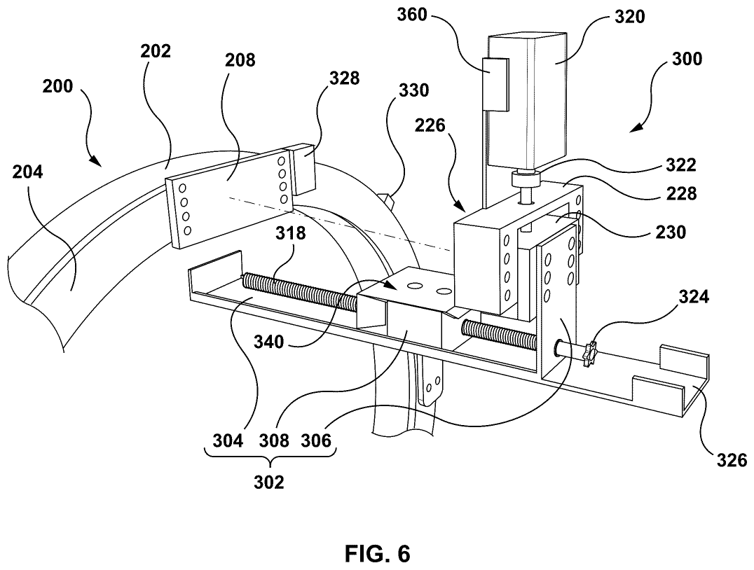

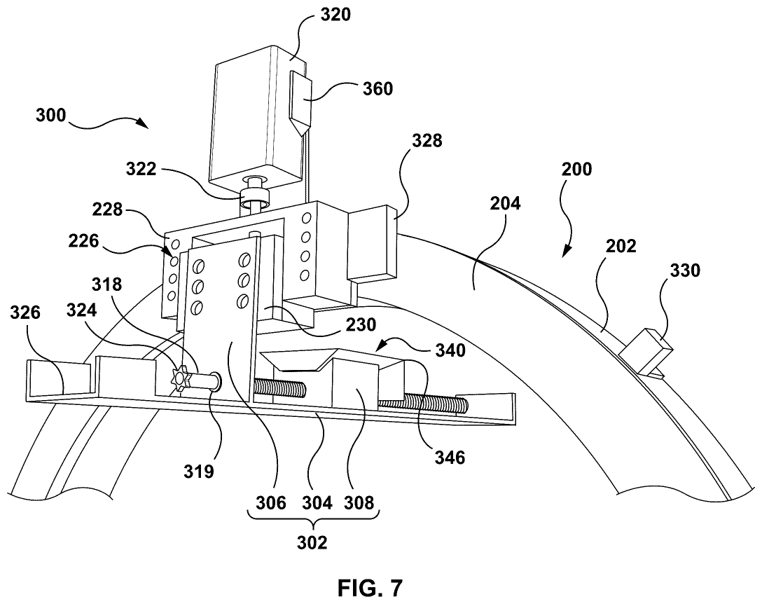

An example device 300 for facilitating removal of elastomeric polymer liner material from inside an end section of a pipe is depicted in FIGS. 6, 7, and 8. FIG. 6 is a top left perspective view of the device 300 also showing a portion of the annular lathe 200 to which the device 300 may be attached during use. FIG. 7 is a bottom right perspective view of the device 300 of FIG. 6 after its attachment to the annular lathe 200. FIG. 8 shows the device 300 in isolation in exploded view. For clarity, the lined pipe 150 is omitted from each of FIGS. 6, 7, and 8.

In each of FIGS. 6 and 7, the device 300 is depicted in a first configuration as it may appear during a first stage of cutting, which may be referred to as a radial “plunge cutting” stage. The device 300 also has a second configuration that is used during a second stage of cutting operation, which may be referred to as the “axial cutting” stage, as will described.

As illustrated in FIGS. 6-8, the device 300 includes a knife support structure 302. In the present embodiment, the knife support structure 302 includes a knife carriage arm 304 and a mounting bracket 306 extending substantially orthogonally from the knife carriage arm 304. The knife carriage arm 304 supports the knife 340 (described below) that is used to cut the liner 104 inside the pipe. The mounting bracket 306 serves as a point of attachment of the knife support structure 302 to the annular lathe 200 via tool slide 226. The knife carriage arm 304 and mounting bracket 306 are rigid, e.g., being formed from a unitary piece of strong metal such as steel.

The knife support structure 302 of the depicted device 300 further includes a knife holder 308, which is perhaps best seen in FIG. 8. The knife holder 308 is a rigid block having a recessed upper surface 310 shaped to mate tightly with a complementary surface 312 of the knife 340. These mating surfaces may help to maintain the knife 340 in a working orientation, described below.

In the present embodiment, the knife holder 308 is configured to slidably engage a rail 314 defined along the knife carriage arm 304. In FIG. 8, the rail 314 is depicted as a pair of parallel upstanding guides at either side of the knife carriage arm 304. The rail 314 may be designed to prevent the knife holder 308 from lifting away from the knife carriage arm 304, e.g., via a slidable interlocked relationship.

The knife holder 308 has a threaded bore 316 therethrough that is parallel to the rail 314 (see FIG. 8). The threaded bore 316 engages a threaded rod 318 that is also parallel to the rail 314. The threaded rod 318 is axially fixed relative to the rail 314 while remaining rotatable, e.g., by virtue of being held by a bearing 319 in bracket 306. As a result, rotation of the threaded rod causes axial movement of the knife holder 308 along the rail 314.

Rotation of the threaded rod 318 may be actuated by a DC motor 320 (a form of rotary actuator), which may for example be a 12V DC motor of the type used in portable electric drills. As illustrated, the motor 320 has a rotary shaft 321 terminated by a socket 322 (a form of mechanical connector). The socket 322 of the present embodiment is suitable for mechanically engaging either of a star wheel 324 at the end of threaded rod 318 and a star wheel 231 at the end of a threaded rod 229 of the tool slide 226.

A motor support bracket 326 on an opposite side of mounting bracket 306 is configured to support the DC motor 320 with socket 322 mechanically engaging star wheel 324. The DC motor 320 will so occupy the motor support bracket 326 during a second, axial cutting stage of operation, described below. Collectively, the rail 314, threaded bore 316, threaded rod 318, and DC motor 320 may be considered to comprise an axial feed mechanism 332.

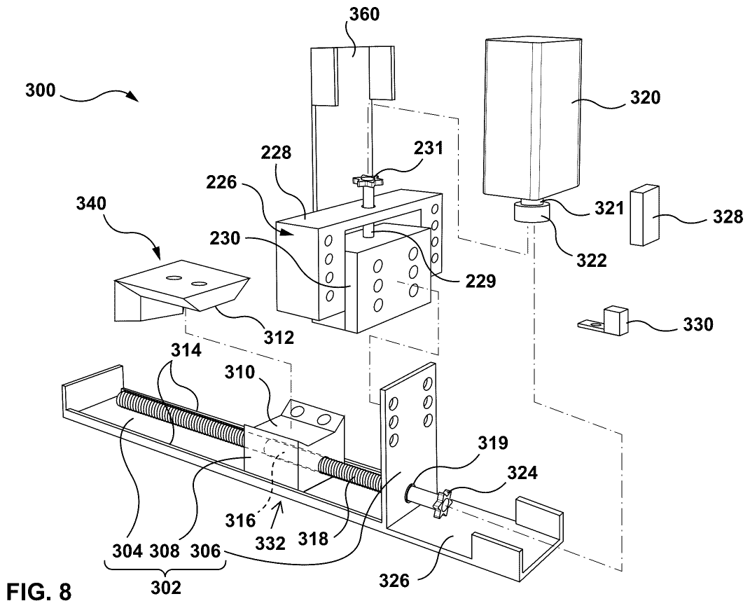

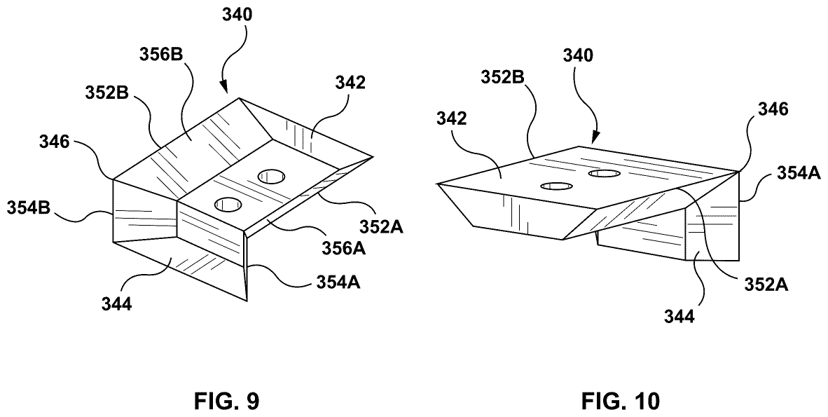

The knife 340 component of device 300 is shown in more detail in FIGS. 9-13. FIGS. 9 and 10 illustrate the knife 340 in bottom left isometric view and top right isometric view, respectively. FIGS. 11, 12, and 13 illustrate the knife 340 in bottom view, left side elevation view, and front elevation view, respectively.

As illustrated, the knife 340 has an axial blade portion 342 and a radial blade portion 344 joined to form a heel 346. The axial and radial blade portions 342 and 344 are so named by virtue of their intended orientation during use, as will be described. In the present embodiment, the axial blade portion 342 forms a right angle with the radial blade portion 344, as perhaps best seen in FIG. 12. In alternative embodiments, the angle K between the axial and radial blade portions 342, 344 may be greater than or less than 90 degrees. It will be appreciated that, in cases where K is greater than or less than 90 degrees, the axial orientation of the axial blade portion 342 when the knife 340 is in the working orientation will be unchanged from the case where K is 90 degrees. However, the radial blade portion 344 will to some extent be inclined away from a purely radial orientation.

Each of the axial blade portion 342 and radial blade portion 344 of the present embodiment has a substantially trapezoidal cross-sectional shape, which is perhaps best seen in FIG. 9. In some embodiments, the knife 340 may be made from a chipper knife, such as a Vermeer® Model BC1000 Compatible Brush Chipper Knife. For example, such a chipper knife may be cut into two portions, e.g., using a water jet, and the two portions may be welded together at an angle to form the depicted knife 340.

The axial blade portion 342 has a primary cutting edge 352A, and the radial blade portion 344 has a primary cutting edge 354A. These cutting edges 352A and 354A face in the same direction and meet at heel 346 (see, e.g., FIG. 10). The axial and radial blade portions 342 and 344 also have alternative cutting edges 352B and 354B, respectively, each facing in an opposite direction from, and parallel to, its respective primary cutting edge 352A and 354A. The alternative cutting edges 352B and 354B similarly meet at heel 346 (see, e.g., FIG. 9). The axial blade portion 342 has flat cutting faces 356A and 356B adjacent to cutting edges 352A and 352B, respectively.

It will be appreciated that, when the knife 340 is being used to cut away elastomeric polymer liner material 104 from an end section of a pipe, only one of the two pairs of cutting edges-either the primary pair 352A and 354A or the alternative pair 352B and 354B-will be used at any given time. The alternative cutting edges 352B and 354B are provided to extend the useful life of the knife 340. In particular, the primary cutting edges 352A and 354A of a new knife 340 may be used until they have become dull. Thereafter, the alternative cutting edges 352B and 354B may instead be used for cutting. This may conveniently be done by reversing a direction of rotational movement of the knife, e.g., by reversing the direction of rotation of the rotatable annular part 204 of the annular lathe 200 from clockwise to counter-clockwise. Alternative cutting edges are not strictly required, but their absence may necessitate more frequent replacement of the knife 340.

In the present embodiment, the width W of the axial blade portion 342 of the knife, as measured between the primary cutting edge 352A and the alternative cutting edge 352B, is 4.5 inches (see FIG. 11). This width is approximately 6.65 times smaller than the 30-inch inner diameter of the example pipe 102 of the present embodiment. In general, the width W of the axial blade portion 342 may be six to seven times smaller than an inner diameter of the pipe 102. This ratio may differ in alternative embodiments.

In the present embodiment, the axial blade portion 342 has a length L1 of 4.5 inches, and the radial blade portion 344 has a length L2 of 2.5 inches (see FIG. 12). In general, the length L2 of the radial blade portion 344 should be slightly longer (e.g., 0.75 inches longer) than the maximum thickness (depth) of the portion of the liner 104 to be removed from the end section of the pipe. In some embodiments including the present one, L1 is at least 1.5 times L2. This may help to reduce a weight of the knife 340.

The axial blade portion 342 of the present embodiment has a pair of bores 348 therethrough (see FIG. 11). These may be used to facilitate removable attachment of the knife 340 to the knife holder 308, e.g., using threaded fasteners such as bolts.

Referring again to FIGS. 6-8, the device 300 further includes a tool slide block assembly 226. In the present embodiment, this component is the same tool slide block assembly 226 as was used for severing the pipe spool 100 (see FIGS. 4 and 5). The tool slide block assembly 226 serves as an indirect point of attachment of the knife support structure 302 to the annular lathe 200.

As noted above, operation of the device 300 for facilitating removal of the liner 104 from the pipe 150 occurs in two phases: a cutting phase and a stripping phase. The cutting phase is intended to remove substantially all the liner material from the end section 162 of the pipe 150 using the knife 340. The stripping phase is intended to remove any remnants of liner material that may remain clinging to the inner surface of the pipe after the cutting phase.

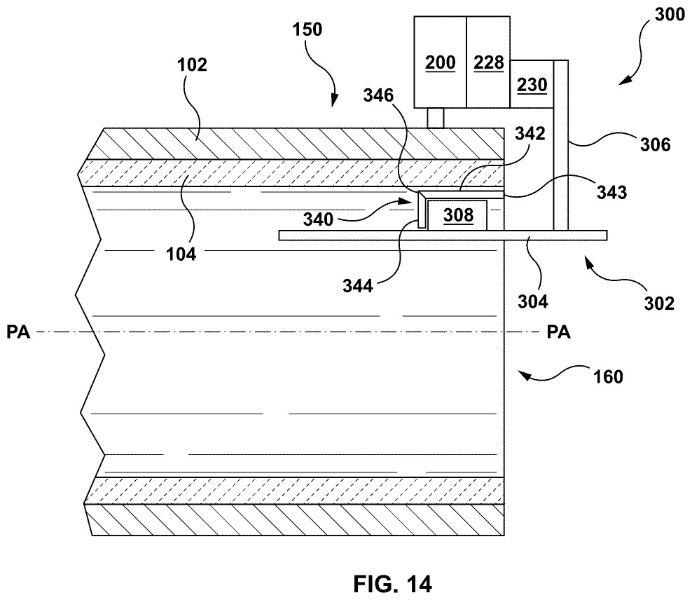

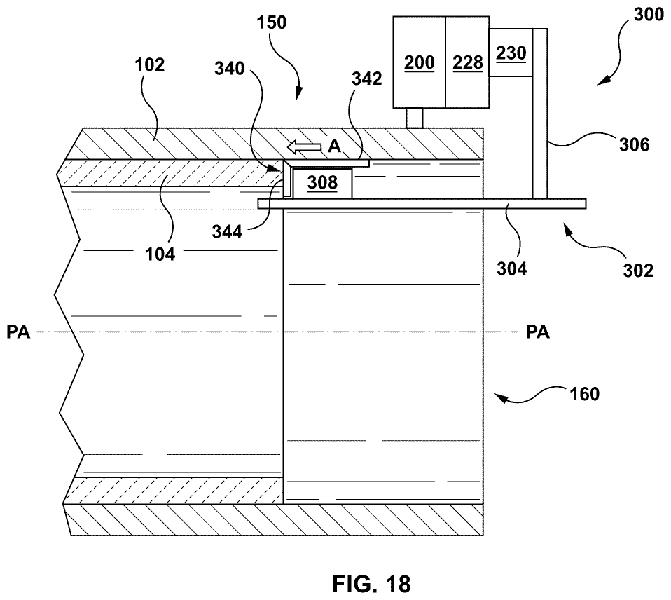

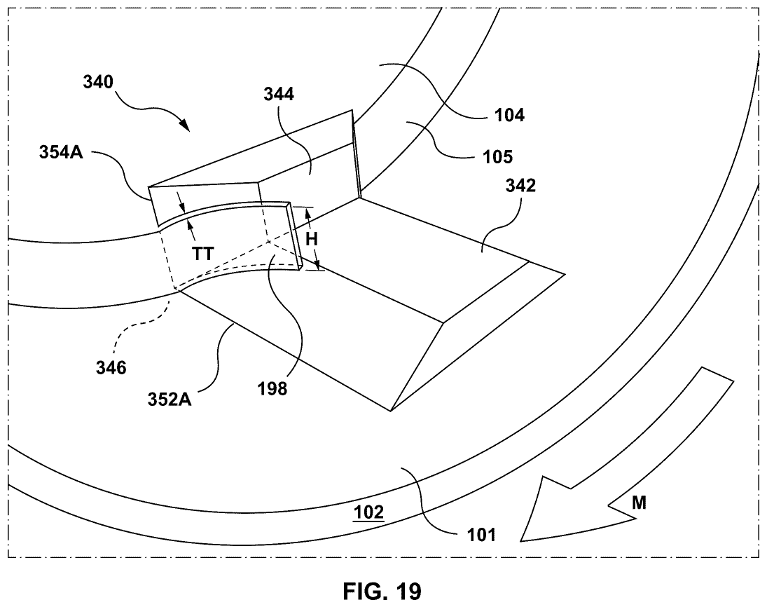

The cutting phase occurs in two stages: a radial plunge cutting stage and an axial cutting stage. The radial plunge cutting stage is depicted in FIGS. 14 to 17. The axial cutting stage is depicted in FIGS. 18 and 19.

For the radial plunge cutting stage, the device 300 is configured as shown in FIG. 7. More specifically, the mounting bracket 306 of the knife support structure 302 is attached to the tool block 230 of the tool slide 226, and the base 228 of the tool slide 226 is attached to the tool mount 208 of the annular lathe 200. The knife support structure 302 may thus be considered indirectly attached to the annular lathe 200 by way of the tool slide 226.

During the radial plunge cutting stage, the DC motor 320 is held by a motor support bracket 360 similar to motor support bracket 326, described above. The motor support bracket 360 is oriented radially and is attached to the rotatable annular part 204 of the annular lathe 200 either directly or indirectly. The motor support bracket 326 holds the DC motor 320 so that the socket 322 mechanically engages the star wheel 231 of tool slide 226. The DC motor 320 may be secured to bracket 360 in that configuration, e.g., using a removable strap or ties (not depicted).

The configuration of device 300 at the commencement of the plunge cutting stage is shown in FIG. 14. FIG. 14 is a not-to-scale schematic side view of the device 300 attached to the annular lathe 200 with the lined pipe 150 shown in cross section. The annular lathe 200 is secured to the exterior of the pipe 150 so that the axis of rotation of rotatable annular part 204 (not depicted) is substantially coaxial with the pipe axis PA.

In FIG. 14, the device 300 is shown at the twelve o'clock position of the annular lathe 200. This may be for convenience of installation of device 300 onto annular lathe 200. The rotatable annular part 204 may be locked relative to the stationary annular part 202 during the installation. It will be appreciated that the rotatable annular part 204 of annular lathe 200 could be rotated so that the installation of device 300 takes place at another position about its circumference.

As shown in FIGS. 7 and 14, the knife support structure 302 of the installed device 300 is configured to support the knife 340 in a working orientation. The working orientation of the knife 340 is one in which the axial blade portion 342 and the radial blade portion 344 are oriented axially and radially, respectively, relative to the pipe 102, and the axial blade portion 342 is further from an axis of the pipe than the radial blade portion. Keeping the knife 340 in this orientation throughout cutting may limit a risk of damage to an inner surface of the pipe 102 from a corner of the axial blade portion 342 (e.g., heel 346). Features of the device 300 that may help to keep the knife 340 in the working orientation during cutting may for example include rigid construction of knife support structure 302, tight mating of knife 340 with knife holder 308, and avoidance of excessive wear in wear parts such as bearing 319, among others.

In the present embodiment, the knife 340 is oriented for heel-first axial entry into the open end 160 of the pipe 102. In other words, the knife support structure 302 supports the knife 340 so that the radial blade portion 344 is axially further (deeper) in the pipe that the axial blade portion 342. This is not strictly required but may be advantageous in certain respects. For example, as will become apparent, an operator standing at the open end 160 of the lined pipe 150 during liner removal may be able to better see cutting progress with the knife 340 oriented as described, particularly when the knife 340 is in the outboard position.

At the commencement of plunge cutting, the knife 340 is placed in an inboard position (see, e.g., FIG. 14). The term “inboard” as used herein refers to a radial position of the knife 340 in which the cutting edge 352A of the axial blade portion 342 is inwardly (radially) clear of the liner 104. In the present embodiment, the knife 340 may be placed in the inboard position by appropriately adjusting the tool slide 226, i.e., by turning star wheel 231 (FIG. 8) to suitably adjust a radial position of the tool block 230 relative to base 228. This adjustment may for example be made before the mounting bracket 306 is attached to the tool block 230.

In the present example, the knife 340 is initially axially positioned so that the end 343 of the axial blade portion 342 furthest from the heel 346 is flush with an end of the pipe (see FIG. 14). As will be appreciated, the result is that the annular portion of the liner 104 that will be removed by the first, plunge cutting stage will be at the open end 160 of the pipe 102.

Referring again to FIG. 7, it can be seen that a rotation sensor 328 is attached to the rotatable annular part 204 of the annular lathe 200 adjacent to the tool slide 226. The sensor 328 has a complementary trigger 330, which in this embodiment is attached to the stationary annular part 202 of the annular lathe 200. The rotation sensor has two modes of operation: active and inactive. In the active mode, the rotation sensor 328 is configured to generate a signal when it comes into contact or close proximity with the trigger 330. In the active mode, the rotation sensor 328 is prevented from generating this signal. The rotation sensor 328 and trigger 330 may take various forms in different embodiments. In one example, the sensor 328 may be a mechanical switch, and the trigger 330 may be an object that physically contacts the mechanical switch. In another example, the sensor 328 may be an optical sensor, and the trigger 330 may be a light source. In some embodiments, multiple triggers may be situated about the periphery of the stationary annular part 202, e.g., to sense a finer granularity of rotation.

The rotation sensor 328 is electronically coupled to a switch (e.g., a relay—not expressly depicted) for activating the DC motor 320. The electronic coupling may for example comprise suitable wiring (not depicted).

With device 300 securely mounted to the annular lathe 200, rotation of the rotatable annular part 204 of the lathe 200 may be commenced, e.g., by activating a pneumatic motor (not illustrated). The direction of rotation is with primary cutting edges 352A and 354A of knife 340 leading the rotational movement, i.e., clockwise as viewed from the open end 160 of the pipe 150. With the rotation sensor 328 in operational mode, an electronic signal (e.g., pulse) will be generated whenever the rotation sensor 328 rotates past trigger 330. It will be appreciated that each pulse after the first will be indicative of a predetermined extent of rotation (here, a single revolution) of the knife support structure 302 about the axis PA of the pipe 102.

In the present embodiment, each pulse from the active rotational sensor 328 activates a switch (not illustrated), causing the shaft 321 and socket 322 of the DC motor 320 to rotate for a predetermined time interval. The rotation of the socket 322 in turn rotates the star wheel 231. The direction of rotation is chosen to cause the tool block 230 to advance radially outwardly towards the wall of the pipe 102. Each rotation will accordingly move the knife support structure 302 radially outwardly, bringing the knife 340 progressively closer to the liner 104.

When the cutting edge 352A of the axial blade portion 342 reaches the liner 104, it will “plunge” into the liner 104 and begin cutting it along an annular trajectory. With each revolution of the annular lathe 200, the knife 340 will shave away a ribbon of the elastomeric polymer material from liner 104.

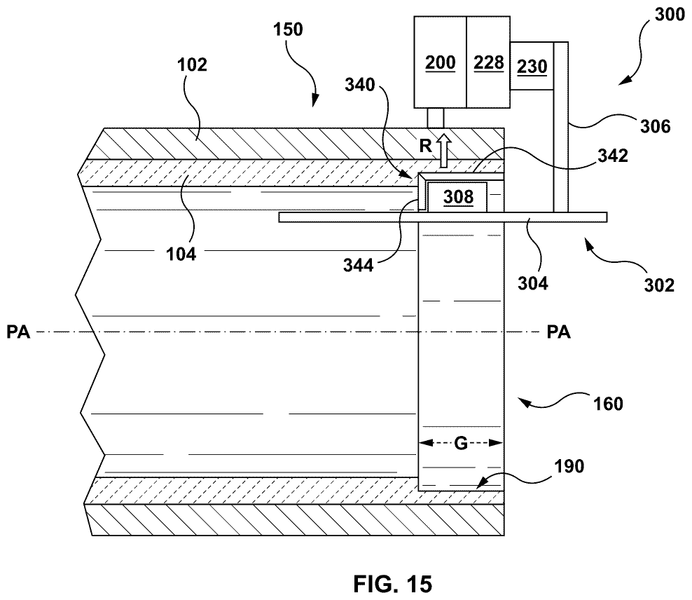

FIG. 15 is a schematic side view of the device 300 partly through the plunge cutting stage of operation. The conventions of FIG. 15 are similar to those of FIG. 14. The upward arrow R denotes advancement of the knife 340 axially outwardly from the inboard position of FIG. 14. In FIG. 15, the knife 340 has cut an annular groove 190 into the liner 104 over the course of multiple orbits about pipe axis PA. It will be appreciated that the width G of the groove matches the length L1 (FIG. 12) of the axial blade portion 342.

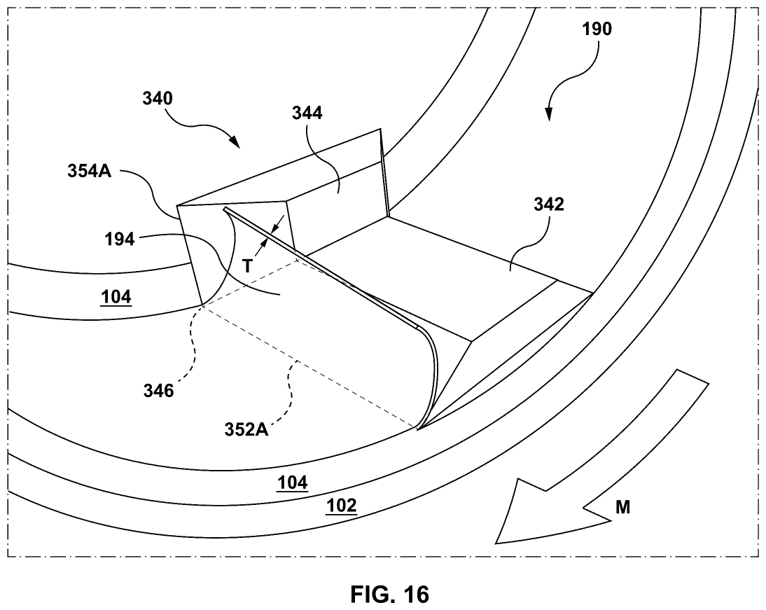

FIG. 16 is a perspective view of the knife 340, as viewed from the open end 160 of the pipe 150, partly through the plunge cutting stage of operation. FIG. 16 illustrates the manner in which the knife 340 cuts a single ribbon 194 of elastomeric polymer material from liner 104 during the plunge cutting stage. To avoid visual obstruction, only the knife 340 component of device 300 is depicted in FIG. 16. The rotational movement of the knife 340 is in direction M, i.e., clockwise.

As illustrated, most of the cutting or “shaving away” of the ribbon 194 during the plunge cutting stage is performed by the axially oriented primary cutting edge 352A of the axial blade portion 342. However, the radially oriented primary cutting edge 354A of the radial blade portion 344 closest to the heel 346 of the knife 340 also simultaneously cuts the ribbon 194 radially, away from the remainder of the liner 104. The thickness T of the ribbon 194 is determined by the extent of outward radial advancement of the knife 340 since its previous cutting pass. For example, the thickness T may be approximately one-sixteenth of an inch in some embodiments. This thickness may be adjusted as appropriate for different embodiments, e.g., by adjusting the duration of activation of the DC motor 320 for each revolution of the annular lathe 200. It will be appreciated that the width of the ribbon 194 matches the length L1 of the axial blade portion 342 (see FIG. 12).

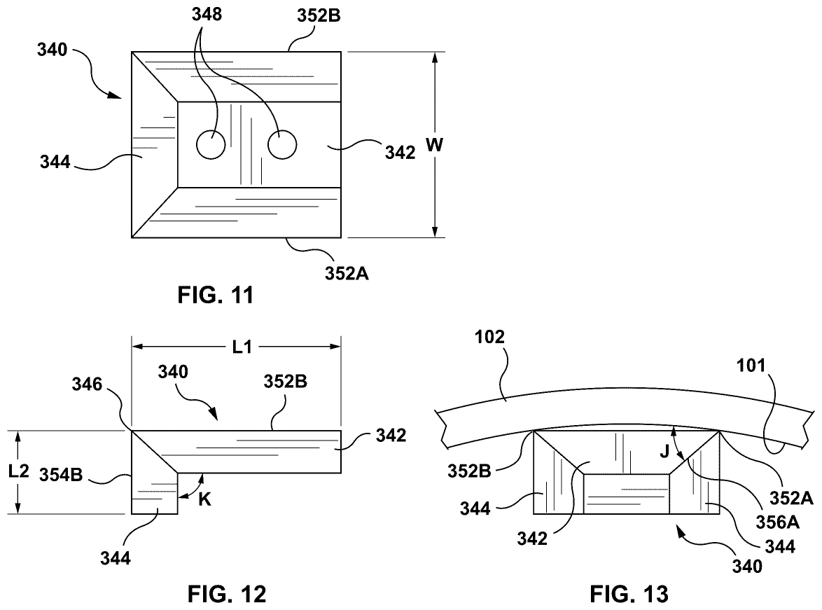

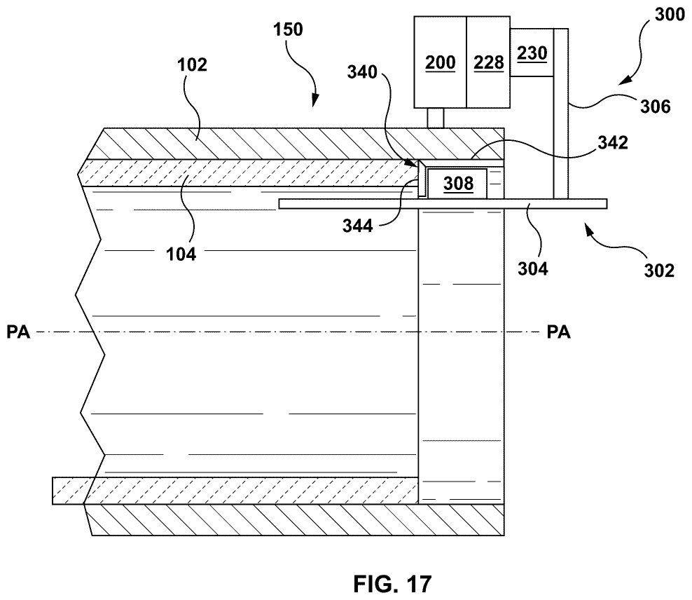

FIG. 17 is a schematic side view of the device 300 at the conclusion of the plunge cutting stage of operation. FIG. 17 adopts similar conventions to those used in FIGS. 14 and 15. As illustrated, an annular portion of the elastomeric polymer material has been shaved away from the end section of the pipe. In FIG. 17, the knife 340, still in its working orientation, has reached an outboard position. In the outboard position, the cutting edge 352A of the axial blade portion 342 is adjacent to the inner surface 101 of the pipe 102. In this position, the flat cutting face 356A immediately adjacent to the primary cutting edge 352A forms an angle J with the inner surface 101 of the pipe wall (see FIG. 13). In one embodiment, the angle J is approximately 30 degrees. This angle may be suitable for effectively shaving away elastomeric polymer material having a durometer of approximately 87 Shore A. If the angle is too small, the cutting edge may not be able to effectively “bite” into the elastomeric polymer material. If the angle is too large, the knife 340 may chatter. The optimal angle may differ for elastomeric polymer materials of different durometers. Device 300 may be used with multiple swappable knives, each forming a different angle J that is optimal for a cutting a respective type of elastomeric polymer material.

At the conclusion of the plunge cutting stage, rotation of the rotatable annular part 204 of annular lathe 200 may be halted. In preparation for the axial cutting stage of operation of device 300, the DC motor 320 may be removed from the motor support bracket 360 and placed into the other motor support bracket 326. The socket 322 of the DC motor 320 may be mechanically engaged with the star wheel 324, and the DC motor 320 may be secured to the motor support bracket 326.

In some embodiments, the end of the knife carriage arm 304 furthest from the mounting bracket 306 may be stabilized prior to commencement of the axial cutting stage. This may be intended to reduce a risk that the knife 340 will deviate from its working orientation upon being subjected to the forces inherent in this stage. Stabilization may for example be achieved by attaching additional support structure or bracing between that end of the knife carriage arm 304 and the rotatable annular part 204 of the annular lathe 200. The support structure may take the form of an A-frame member that is anchored to, and spans between, the annular lathe brackets 226 (not expressly depicted).

To commence the axial cutting stage, clockwise rotation of the rotatable annular part 204 of the lathe 200 may be resumed with the knife 340 still in the outboard position and in the working orientation. With each revolution, the rotation sensor 328 (when in its active mode) generates a signal that causes the DC motor 320 to activate for a predetermined time interval. This causes the star wheel 324, and thus threaded rod 318, to rotate by a predetermined extent. The direction of rotation is such that the knife holder 308 slides axially along rail 314 to translate the knife 340 heel-first. In this case, that direction is away from the mounting bracket 306. Each revolution of the annular lathe 200 of the present embodiment will accordingly cause the knife 340 to move axially deeper into the pipe 150 by a predetermined amount without changing the radial position of the knife 340.

FIG. 18 is a schematic side view of the device 300 during the axial cutting stage of operation. The conventions of FIG. 18 are similar to those of FIG. 14. The arrow A denotes progressive heel-first movement of the knife 340 axially into the pipe 150. In FIG. 18, the knife 340 has removed substantially all of the liner 104 from an axial extent of the pipe 102 closest to the end 160 of the pipe over the course of multiple orbits about pipe axis PA.

FIG. 19 is a perspective view of the knife 340 partly through the axial cutting stage of operation as viewed from the end 160 of the pipe 150. FIG. 19 illustrates the manner in which the knife 340 cuts a single strip 198 of elastomeric polymer material from liner 104 during the axial cutting phase. To avoid visual obstruction, only the knife 340 component of device 300 is depicted. The rotational movement of the knife 340 in FIG. 19 is in direction M, i.e., clockwise.

As illustrated, most of the cutting of the strip 198 during the axial cutting stage is performed by the radially oriented primary cutting edge 354A of the radial blade portion 344. However, the axially oriented primary cutting edge 352A of the axial blade portion 342 closest to the heel 346 of the knife 340 does simultaneously cut the strip 198 axially, away from the inner surface 101 of the pipe 102. The thickness TT of the strip 198 is determined by the degree of axial movement of the knife 340 since is previous cutting pass. In some embodiments, the thickness TT may be approximately 0.375 inches.

It will be appreciated that, during the axial stage of cutting operation, the radial blade portion 344 of the knife 340 cuts through substantially the entire radial thickness of the liner 104 with each revolution of the annular lathe 200. Thus, the height H of the strip 198 will be substantially equivalent to the thickness of the liner 104. The cutting away of the strip 198 in the radial dimension will leave a clean annular face 105 on the remaining liner 104. In the present embodiment, the face 105 is orthogonal to the inner surface 101 of the pipe 102. A clean face 105 may facilitate the splicing of an annular section of replacement liner into the end section of the pipe when the pipe 150 is eventually joined with another pipe spool.

It will be appreciated that, when the primary cutting edges 352A, 354A of knife 340 become dull, the device 300 may still be used to cut liner 104 by reversing the direction of rotation of the annular lathe 200 from clockwise to counter-clockwise. This will result in the alternative cutting edges 352B, 354B of knife 340 becoming the leading edges. When the alternative cutting edges become dull, the knife 340 may be replaced.

With the cutting phase of operation of device 300 concluded, the knife support structure 302 may be detached from the tool slide 226. To commence the stripping phase, a stripper support structure 402 may be attached to the tool slide.

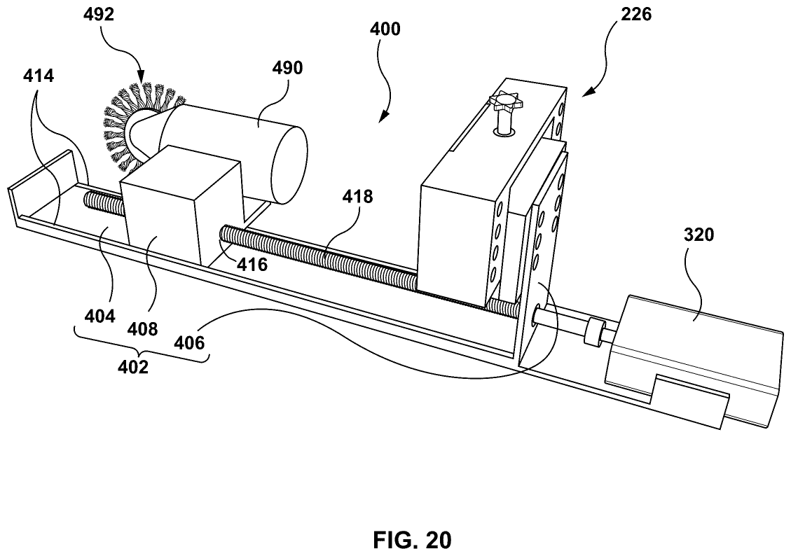

FIG. 20 is a perspective view of a stripper carriage 400 including stripper support structure 402. It will be appreciated that the stripper support structure 402 is similar in many respects to the knife support structure 302 described above. For example, the stripper support structure 402 has a stripper carriage arm 404 with an axial rail 414, a mounting bracket 406, a stripper holder 408 with a threaded bore 416, and an axially fixed rotatable threaded rod 418 engaging the threaded bore and terminated by a star wheel (not visible in FIG. 20). Each of these components is analogous to its counterpart component of the knife support structure 302, described above. Rotation of the threaded rod 418 causes the stripper holder 408 to slide axially along rail 414, with the direction of sliding being determined by the direction of rotation.

The stripper holder 408 holds a rotary stripper 490 having a wire brush 492 and an actuator (not visible in FIG. 20) for rotating the wire brush 492. The rotary stripper may for example be a battery-powered angle grinder, such as a Dewalt™ 60V Flex Volt® Grinder. The wire brush 492 may for example be a knotted wire brush, such as a Forney™ 72759 Wire Wheel Brush Twist Knot with threaded arbor, 4 inch by 0.02 inch.

In preparation for the stripping phase, the stripper support structure 402 is attached to the annular lathe 200. In the present embodiment, the attachment is indirect via the tool slide 226. However, the attachment could be direct in alternative embodiments. The stripper holder 408 holds the rotary stripper 490 in a stripping orientation in which at least a portion of the wire brush 492 will be in contact with the inner surface 101 of the pipe 102.

To commence the stripping phase, the actuator of the rotary stripper 490 may be activated to cause the wire brush 492 to rotate. The annular lathe 200 may then be activated to initiate rotation of the stripper carriage 400 about the axis of the pipe with the rotary stripper 490 in the stripping orientation and the rotary actuator rotating the wire brush 492. As the stripper support structure 402 rotates about the pipe, the DC motor 320 may cause the stripper holder 408 to progressively move axially along the rail 414, using the same mechanism as was used to move the knife 340 axially along rail 314 during the axial cutting stage (see, e.g., FIGS. 18 and 19, described above). Any remaining bits of elastomeric polymer liner material still clinging to the inner surface 101 of the end section 162 of the pipe 102 may thereby be stripped away.

Various alternative embodiments are possible.

It is possible for the orientation of knife 340 to be reversed so that the heel 346 enters the pipe 150 last. In this case, the knife 340 may be axially aligned at the commencement of the plunge cutting stage so that the annulus of elastomeric polymer material that is removed from liner 104 by plunge cutting is within the end section 162 pipe away from the open end 160. Thereafter, the knife 340 may be made to move heel-first axially towards (not away from) the open end 160 of the pipe 150 during the axial cutting stage. This approach may be less desirable from an operator visibility standpoint. The reason is that the operator's view of the axial blade portion 342 of the knife 340 in the outboard position may be obstructed by as-yet unremoved liner 104.

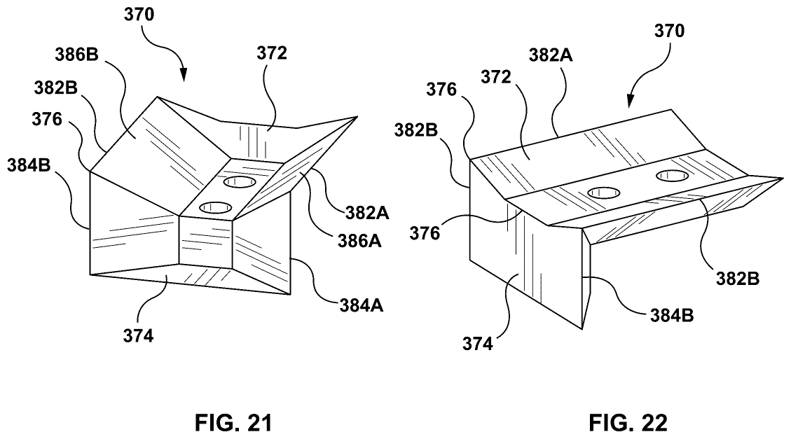

In some embodiments, the axial blade portion of the knife may be shaped differently, with its cutting edges raked radially outwardly from the body of the axial blade portion, i.e., raked in a direction opposite to the direction in which the radial blade portion extends from the heel of the knife. The reason may be to improve cutting performance for certain durometers of elastomeric polymer material during the plunge cutting stage. This is depicted in FIGS. 21 and 22.

FIGS. 21 and 22 illustrate an alternative embodiment of knife 370 in bottom left isometric view and top right isometric view, respectively. The knife 370 is similar in many respects to the knife 340, described above. For example, the knife 370 has an axial blade portion 372 and a radial blade portion 374 joined to form a heel 376. The axial blade portion 372 has a primary cutting edge 382A, and the radial blade portion 374 has a primary cutting edge 384A. These cutting edges 382A and 384A face in the same direction and meet at heel 376. The axial and radial blade portions 342 and 344 also have alternative cutting edges 382B and 384B, respectively, each facing in an opposite direction from, and parallel to, its respective primary cutting edge 382A and 384A. The alternative cutting edges 352B and 354B similarly meet at heel 376. The axial blade portion 372 has flat cutting faces 386A and 386B adjacent to cutting edges 382A and 382B, respectively.

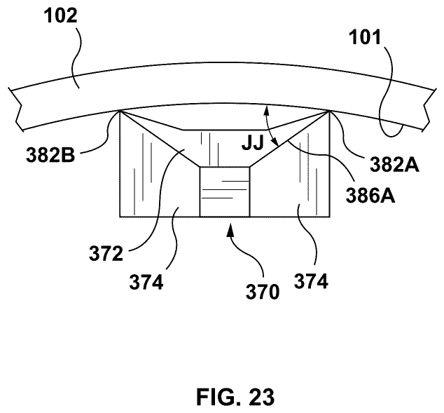

FIG. 23 is a schematic side view of the knife 370 in the working orientation upon having reached an outboard position at the conclusion of radial plunge cutting. In the outboard position, the cutting edge 382A of the axial blade portion 372 is adjacent to the inner surface 101 of the pipe 102. In this position, the flat cutting face 386A immediately adjacent to the primary cutting edge 382A forms an angle JJ with the inner surface 101 of the pipe wall. In one embodiment, the angle JJ is approximately 45 degrees. It is believed that this angle should be suitable for shaving away elastomeric polymer material having a durometer of approximately 70 Shore A or similar. In another embodiment, the cross-sectional shape of the axial blade portion 372 may be trapezoidal like that of axial blade portion 342, albeit with a 45-degree angle of flat cutting face 386A.

Other modifications may be made within the scope of the claims.

What is claimed is:

1. A device for facilitating removal of elastomeric polymer liner material from inside a pipe, the device comprising:
a knife having an axial blade portion and a radial blade portion joined to form a heel with respective cutting edges of the axial and radial blade portions facing in the same direction, the knife having a working orientation in which the axial and radial blade portions are oriented axially and radially, respectively, relative to the pipe and the axial blade portion is further from an axis of the pipe than the radial blade portion;
wherein rotation of the knife about the axis of the pipe in the working orientation with the cutting edges leading and with the knife in contact with the elastomeric polymer liner material causes the cutting edge of the axial blade portion to cut through the elastomeric polymer liner material along an annular trajectory and additionally causes the cutting edge of the radial blade portion to simultaneously cut through the elastomeric polymer liner material in a radial dimension of the pipe.

2. The device of claim 1 wherein the axial blade portion has a flat cutting face, adjacent to the cutting edge of the axial blade portion, that forms an angle of approximately 30 degrees with an inner surface of the pipe when the knife is in the working orientation in an outboard position adjacent to the inner surface of the pipe.

3. The device of claim 1 wherein a width of the axial blade portion of the knife, as measured between the cutting edge of the axial blade portion and an opposite edge of the axial blade portion, is six to seven times smaller than an inner diameter of the pipe.

4. The device of claim 1 wherein the cutting edges of the axial and radial blade portions of the knife are primary cutting edges and wherein each of the axial and radial blade portions further comprises an alternative cutting edge, the alternative cutting edges of the axial and radial blade portions facing in an opposite direction from the primary cutting edges of the axial and radial blade portions respectively.

5. The device of claim 1 wherein the axial blade portion forms a right angle with the radial blade portion.

6. The device of claim 1 wherein a length of the axial blade portion is at least 1.5 times a length of the radial blade portion.

7. The device of claim 1 wherein the axial blade portion of the knife is shaped so that, in the working orientation, the cutting edge of the axial blade portion is raked radially outwardly relative to a body of the axial blade portion.

8. A method of facilitating removal of elastomeric polymer liner material lining an inner surface of a pipe, the method comprising:
orienting a knife in a working orientation with respect to the pipe, the knife having an axial blade portion and a radial blade portion joined at a heel with respective cutting edges of the axial and radial blade portions facing in the same direction, wherein the axial and radial blade portions are oriented axially and radially, respectively, relative to the pipe, with the axial blade portion being further from an axis of the pipe than the radial blade portion; and
rotating the knife about the axis of the pipe in the working orientation with the cutting edges leading and with the knife in contact with the elastomeric polymer liner material to cause the cutting edge of the axial blade portion to cut through the elastomeric polymer liner material along an annular trajectory and to simultaneously cause the cutting edge of the radial blade portion to cut through the elastomeric polymer liner material in a radial dimension of the pipe.

9. The method of claim 8 further comprising progressively advancing the knife radially outwardly with respect to the pipe to progressively shave away a ribbon of the elastomeric polymer liner material.

10. The method of claim 8 further comprising progressively advancing the knife axially and heel-first along the pipe to progressively cut away a strip of the elastomeric polymer liner material.

11. The method of claim 8 wherein the rotating of the knife is in one of a clockwise direction and a counter-clockwise direction, wherein the cutting edges of the axial and radial blade portions of the knife are primary cutting edges, wherein each of the axial and radial blade portions further comprises an alternative cutting edge, the alternative cutting edges of the axial and radial blade portions facing in an opposite direction from the primary cutting edges of the axial and radial blade portions respectively, and further comprising rotating the knife in the other of the clockwise direction and the counter-clockwise direction with the alternative cutting edges leading and with the knife in contact with the elastomeric polymer liner material to cause the alternative cutting edge of the axial blade portion to cut through the elastomeric polymer liner material along the annular trajectory and to simultaneously cause the alternative cutting edge of the radial blade portion to cut through the elastomeric polymer liner material in the radial dimension of the pipe.
